(19) United States
(12) Patent Application Publication
(10) Pub. No.: US 2020/0341418 A1
(43) Pub. Date: Oct. 29, 2020

(54) IMAGE FORMING APPARATUS AND CONTROL PROGRAM FOR IMAGE FORMING APPARATUS

(71) Applicant: Konica Minolta Inc., Tokyo (JP)

(72) Inventor: NOBUYASU TAMURA, Tokyo (JP)

(21) Appl. No.: 16/846,171

(22) Filed: Apr. 10, 2020

(30) Foreign Application Priority Data
Apr. 23, 2019 (JP) 2019-081809

(51) Int. Cl. G03G 15/20

(52) U.S. Cl. CPC G03G 15/2046; G03G 2215/00772; G03G 2215/2032; G03G 15/2064

(57) ABSTRACT

An image forming apparatus includes: an image forming device that forms an image on a sheet; a fixing device that includes a heating member and heats the sheet on which the image is formed by the image forming device, to fix the image on the sheet; a detector that detects a temperature in the fixing device; and a hardware processor that performs PID control of a turn-on rate of the heating member according to a deviation between a detected temperature by the detector and a target temperature, the PID control being in accordance with an expression including at least a proportional term or an integral term and further including a constant term of a value corresponding to an operation condition of the apparatus, wherein the hardware processor calculates an average turn-on rate of the heating member during execution of the operation, and updates the value of the constant term.

The entire disclosure of Japanese patent Application No. 2019-081809, filed on Apr. 23, 2019, is incorporated herein by reference in its entirety.

### BACKGROUND

### Technological Field

The present invention relates to an image forming apparatus and a control program for the image forming apparatus.

### Description of the Related art

A technology is known that suppresses occurrence of a fixing temperature ripple by performing PID control of a turn-on rate of a heater included in a fixing device in an image forming apparatus. For example, JP 2007-241155 A discloses a technology that suppresses the occurrence of the temperature ripple by changing PID coefficients that are parameters of PID control for each operation mode such as during warm-up, during printing, and during standby.

However, in JP 2007-241155 A, only one type of PID coefficients is used during printing, and there is a problem that the occurrence of the temperature ripple is not sufficiently suppressed, for example, at the time of switching the type of the sheet during printing, or at the time of executing image stabilization processing between sheets, and the like. Furthermore, it is necessary to control three PID coefficients respectively included in the proportional term, the integral term, and the derivative term, and in particular there is also a possibility that the processing is complicated.

### SUMMARY

The present invention has been made in view of the above-described problems. Thus, an object of the present invention is to provide an image forming apparatus capable of easily suppressing occurrence of a temperature ripple in a fixing device, and a control program for the image forming apparatus.

To achieve the abovementioned object, according to an aspect of the present invention, an image forming apparatus reflecting one aspect of the present invention comprises: an image forming device that forms an image on a sheet; a fixing device that includes a heating member and heats the sheet on which the image is formed by the image forming device, to fix the image on the sheet; a detector that detects a temperature in the fixing device; and a hardware processor that performs PID control of a turn-on rate of the heating member according to a deviation between a detected temperature by the detector and a target temperature, the PID control being in accordance with an expression including at least a proportional term or an integral term and further including a constant term of a value corresponding to an operation condition of the image forming apparatus, wherein the hardware processor calculates, at an end of operation according to the operation condition, an average turn-on rate of the heating member during execution of the operation, and the hardware processor updates the value of the constant term corresponding to the operation condition with a value of the average turn-on rate calculated by the hardware processor.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus according to an embodiment of the present invention;

FIG. 2 is a diagram illustrating a schematic configuration of a fixing device;

FIG. 3 is a block diagram for explaining a functional configuration of a controller;

FIG. 4 is a diagram illustrating an example of a table that associates an operation condition and a value of a constant term with each other;

FIG. 5 is a flowchart illustrating an example of a procedure of processing of the image forming apparatus;

FIG. 6A is a diagram for explaining a function and effect of the image forming apparatus;

FIG. 6B is a diagram for explaining a function and effect of the image forming apparatus;

FIG. 6C is a diagram for explaining a function and effect of the image forming apparatus;

FIG. 6D is a diagram for explaining a function and effect of the image forming apparatus;

FIG. 7 is a flowchart illustrating another example of the procedure of the processing of the image forming apparatus; and

FIG. 8 is a flowchart illustrating yet another example of the procedure of the processing of the image forming apparatus.

### DETAILED DESCRIPTION OF EMBODIMENTS

Hereinafter, one or more embodiments of the present invention will be described with reference to the drawings. However, the scope of the invention is not limited to the disclosed embodiments. Note that, in the description of the drawings, the same elements are denoted by the same reference numerals, and duplicate descriptions will not be provided. Furthermore, dimensional ratios of the drawings are exaggerated for convenience of description and may be different from actual ratios.

### Image Forming Apparatus

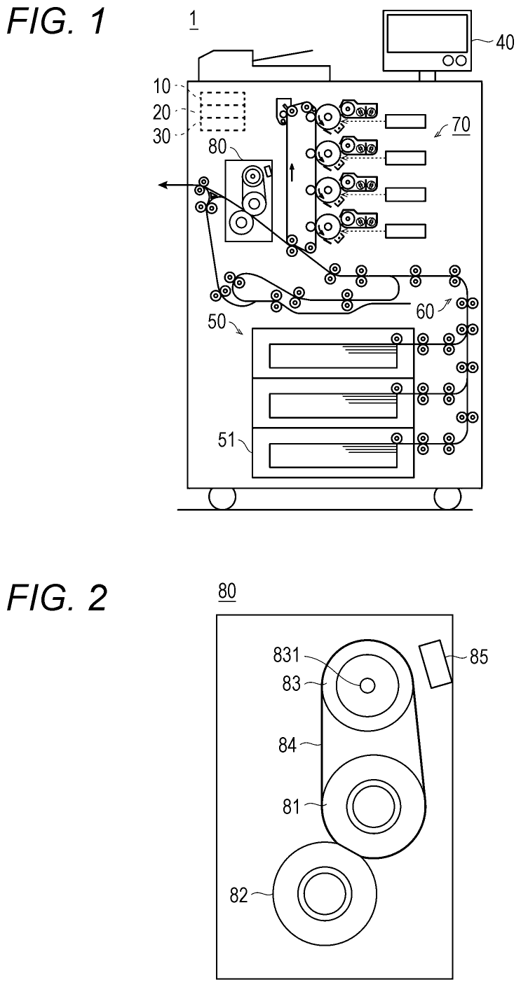

FIG. 1 is a diagram illustrating a schematic configuration of an image forming apparatus according to an embodiment of the present invention. FIG. 2 is a diagram illustrating a schematic configuration of a fixing device.

As illustrated in FIG. 1, an image forming apparatus 1 includes a controller 10, a storage 20, a communication unit 30, an operation panel 40, a sheet feeding unit 50, a conveyance unit 60, an image forming device 70, and a fixing device 80. The components are connected to each other via a bus for exchanging signals.

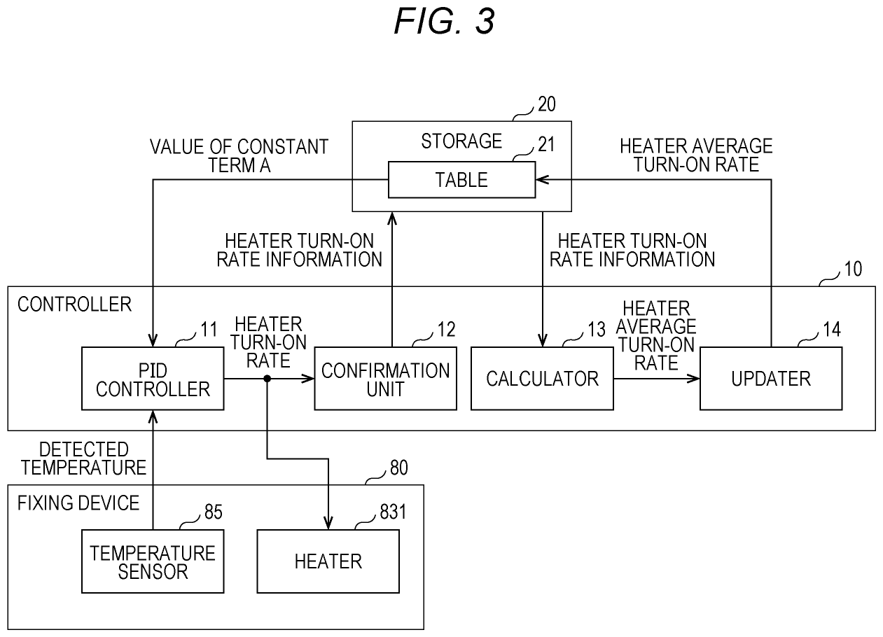

The controller 10 includes a central processing unit (CPU) and executes control of the above-described components and various types of arithmetic processing in accordance with a program. The functional configuration of the controller 10 will be described later with reference to FIG. 3.

The storage 20 includes read only memory (ROM) that stores various programs and various data in advance, random access memory (RAM) as a work area that temporarily stores the programs and data, a hard disk that stores the various programs and various data, and the like.

The communication unit 30 includes an interface for communicating with another device such as a user's personal computer (PC) via a network such as a local area network (LAN). The communication unit 30 receives a print job from the user's PC, for example.

The operation panel 40 includes a touch panel, a numeric keypad, a start button, a stop button, and the like, and displays various types of information, as a display unit, and receives various types of operation, as an operation reception unit.

The sheet feeding unit 50 includes a plurality of sheet feeding trays 51 that stores sheets as recording materials used for printing, and feeds the sheets stored in the sheet feeding trays 51 one by one.

The conveyance unit 60 includes a conveyance path, a plurality of conveying rollers arranged along the conveyance path, and a drive motor (not illustrated) that drives the conveying rollers, and conveys a sheet fed by the sheet feeding unit 50 along the conveyance path.

The image forming device 70 forms an image on the sheet conveyed by the conveyance unit 60 by using a well-known imaging process such as an electrophotographic process.

The fixing device 80 heats and pressurizes the sheet on which the image is formed by the image forming device 70 and that is conveyed by the conveyance unit 60, to fix the image on the sheet. As illustrated in FIG. 2, the fixing device 80 includes a fixing roller 81, a pressure roller 82, a heating roller 83, a fixing belt 84, and a temperature sensor 85.

The fixing roller 81 is arranged to be inscribed in the fixing belt 84 that is an endless belt. The pressure roller 82 is configured to be pressed against the fixing roller 81 facing the pressure roller 82 with the fixing belt 84 interposed therebetween with a predetermined load, and forms a nip (hereinafter referred to as a “fixing nip”) between the pressure roller 82 and the fixing roller 81. The heating roller 83 includes a heater 831 as a heating member therein, is arranged to be separated from the fixing roller 81 and inscribed in the fixing belt 84, and heats the fixing belt 84. The heated fixing belt 84 heats the sheet by passing through the fixing nip together with the sheet conveyed to the fixing device 80. The temperature sensor 85 as a detector detects a temperature of the heated fixing belt 84. In the fixing device 80, power supply to the heater 831, that is, the turn-on rate of the heater 831 (hereinafter, referred to as a “heater turn-on rate”) is controlled so that the temperature detected by the temperature sensor 85 (hereinafter, simply referred to as a “detected temperature”) becomes equal to a target temperature.

The fixing roller 81 and the pressure roller 82 include, for example, an elastic layer made of rubber such as silicon rubber on the outer periphery of a cored bar. Furthermore, examples of the heater 831 include a halogen lamp, a resistance heating element, and an electromagnetic induction heating (IH) type heating unit, and the like. However, the configurations of the fixing roller 81, the pressure roller 82, the heater 831, and the like are not limited to the above-described examples. For example, the pressure roller 82 may include a release layer such as a PFA tube on the outer periphery of the metal base material, or may externally or internally include another heater set at a lower temperature than the heater 831 included in the heating roller 83.

Note that, the image forming apparatus 1 may include components other than the above-described components, or does not have to include some of the above-described components.

### Controller

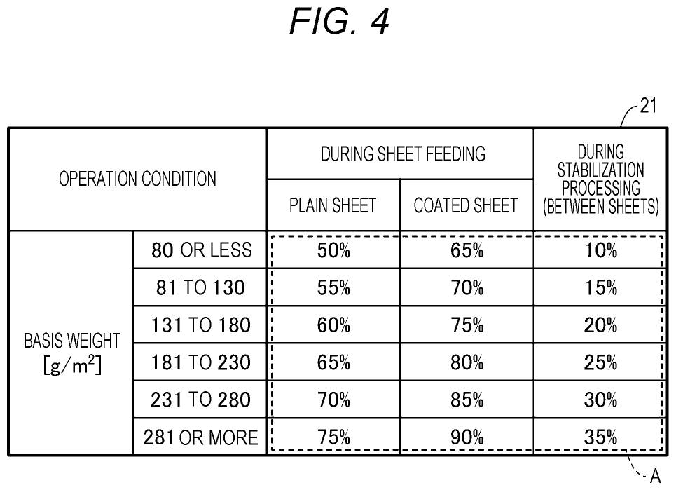

Subsequently, a functional configuration of the controller 10 will be described. FIG. 3 is a block diagram for explaining a functional configuration of the controller. FIG. 4 is a diagram illustrating an example of a table that associates an operation condition and a value of a constant term with each other.

As illustrated in FIG. 3, the controller 10 functions as a PID controller 11, a confirmation unit 12, a calculator 13, and an updater 14 by reading a program and executing processing.

The PID controller 11 performs PID control of the heater turn-on rate according to a deviation (difference) between the detected temperature by the temperature sensor 85 and the target temperature. The PID controller 11 increases the heater turn-on rate as the deviation increases when the detected temperature is lower than the target temperature, and decreases the heater turn-on rate as the deviation increases when the detected temperature exceeds the target temperature. In the present embodiment, the PID controller 11 performs control according to the following expression (1).

$$\begin{matrix} [ Expression 1 ] & \\ HEATER TURN \text{-} ON RATE = {K}_{p} e ( t ) + {K}_{i} {\int }_{0}^{t} e ( τ ) d τ + {K}_{d} \frac{de ( t )}{dt} + A & ( 1 )\end{matrix}$$

Here, e(t) indicates a deviation between the detected temperature and the target temperature that changes with time. The expression (1) according to the present embodiment is characterized in that the expression (1) further includes a constant term A of a value (ratio) corresponding to an operation condition of the image forming apparatus 1, as compared to an expression of normal PID control including a proportional term, an integral term, and a derivative term that are based on the deviation e(t) and coefficients Kₚ, Kᵢ and K_{d}. The expression (1) only needs to include at least the proportional term or the integral term in addition to the constant term A, and does not have to include all of the proportional term, the integral term, and the derivative term. For example, the expression (1) may be an expression for P control in which the coefficients Kᵢ and K_{d} are set to zero, or an expression for PI control in which K_{d} is set to zero. Note that, in the present embodiment, controls (including, for example, P control, PI control, and the like) according to the expression (1) including at least the proportional term or the integral term and the constant term A are collectively referred to as PID control.

The operation condition is a condition that affects operation of the image forming apparatus 1 (for example, operation during printing), and includes a condition regarding the type of the sheet (sheet type and basis weight) used for printing, a condition regarding the presence or absence of the sheet passing through the fixing nip (the presence or absence of sheet feeding), and the like, as illustrated in FIG. 4. The condition regarding the type of the sheet is set via the operation panel 40 on the basis of a user operation for setting the type of the sheet stored in each sheet feeding tray 51. Furthermore, the sheet is controlled not to pass through the fixing nip during execution of image stabilization processing between sheets. However, the operation condition is not limited to the example illustrated in FIG. 4, and for example, the classification of the sheet type may further include embossed sheet or the like.

The value of the constant term A as described above is set to a different value for each operation condition, for example, as illustrated in FIG. 4. An initial value of the constant term A may be a predicted value of an average turn-on rate (hereinafter referred to as a “heater average turn-on rate”) of the heater 831 during execution of operation according to each operation condition, which is calculated on the basis of a simulation or the like. Furthermore, in the example illustrated in FIG. 4, the value of the constant term A corresponding to during the execution of the image stabilization processing is segmented for each basis weight, and the basis weight corresponds to basis weight of the sheet that has passed through the fixing nip immediately before the execution of the image stabilization processing. However, the value of the constant term A corresponding to during the execution of the image stabilization processing is not limited to the example illustrated in FIG. 4, and may be set to, for example, one type of value.

At the start of operation according to a new operation condition, the PID controller 11 refers to, for example, a table 21 as illustrated in FIG. 4 stored in advance in the storage 20, to acquire a value (ratio) of the constant term A corresponding to the operation condition. Then, the PID controller 11 sets the acquired value as the value of the constant term A included in the expression (1), and performs control according to the expression (1). Note that, the “start of operation according to the operation condition” includes not only a case where operation according to the operation condition is started from the standby state, but also a case where operation according to one operation condition is ended and operation according to another operation condition is started (start of operation according to an operation condition after the change). That is, the “start of operation according to the operation condition” includes not only a case where printing on an arbitrary type of sheet is started from the standby state, but also a case where printing on one type of sheet is ended and printing on another type of sheet is continuously started.

For example, at the start of printing on a plain sheet having a basis weight of 65 g/m² (gsm), the PID controller 11 refers to the table 21 and sets the value of the constant term A included in the expression (1) to “50%”. Furthermore, during printing, when the type of the sheet is switched from the plain sheet (thin sheet) having the basis weight of 65 g/m² to a plain sheet (thick sheet) having a basis weight of 200 g/m², the PID controller 11 sets the value of the constant term A set to “50%” in the expression (1) to “65%”. Furthermore, when the image stabilization processing is started between plain sheets having the basis weight of 65 g/m², the PID controller 11 sets the value of the constant term A set to “50%” in the expression (1) to “10%”. However, the form in which the operation condition and the value of the constant term A are associated with each other is not limited to the form of the table 21 illustrated in FIG. 4.

Furthermore, when the integral term is included in the expression (1), the PID controller 11 resets a cumulative value of the deviation in the integral term at the start of the operation according to the new operation condition. As a result, the PID controller 11 can perform control so that the heater turn-on rate immediately after the start of the operation (for example, t=0 in the expression (1)) depends only on the value of the constant term A included in the table 21. For example, when the value of the constant term A included in the table 21 is a predicted value of the heater average turn-on rate calculated on the basis of a simulation or the like, the PID controller 11 can quickly perform control so that the heater turn-on rate immediately after the start of the operation is equal to the predicted value of the PID controller 11. Thus, the PID controller 11 can control the heater turn-on rate so that the deviation between the detected temperature and the target temperature becomes small from immediately after the start of the operation, and can suppress occurrence of a temperature ripple.

The confirmation unit 12 confirms the heater turn-on rate controlled by the PID controller 11 at every predetermined period during the execution of the operation according to each operation condition, and stores information regarding the confirmed heater turn-on rate in the storage 20. The predetermined period may be about 0.1 to 1 second (for example, 0.2 seconds), but is not limited to this.

The calculator 13 calculates the heater average turn-on rate during the execution of the operation on the basis of the information regarding the heater turn-on rate confirmed during the execution of the operation according to each operation condition, which is stored in the storage 20. The calculator 13 calculates the heater average turn-on rate by, for example, dividing a total value of the heater turn-on rates confirmed by the confirmation unit 12 by the number of times confirmed.

Note that, the heater average turn-on rate may be calculated on the basis of the turn-on time of the heater 831. More specifically, the confirmation unit 12 confirms the turn-on time of the heater 831 during the execution of the operation according to each operation condition, and the calculator 13 divides a total value of the turn-on time of the heater 831 by an execution time of the operation, whereby the heater average turn-on rate may be calculated.

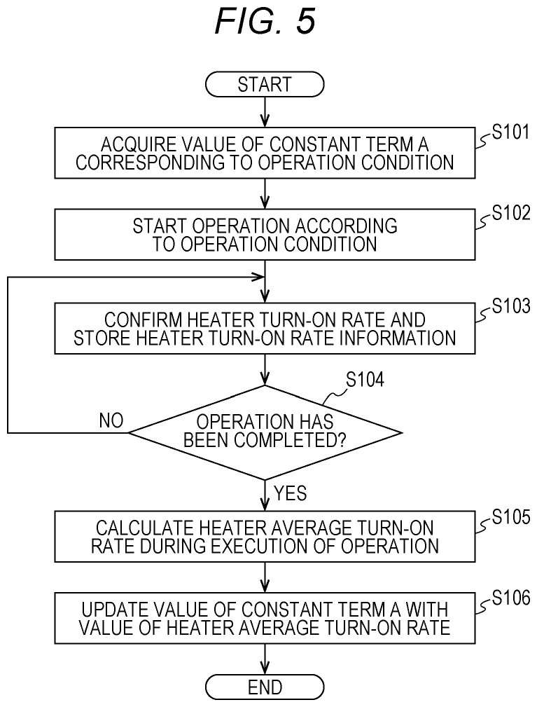

The updater 14 updates the value of the constant term A included in the table 21 with a value of the heater average turn-on rate calculated immediately before. Details of update processing of the updater 14 will be described later with reference to FIG. 5.

### Processing

Subsequently, a procedure will be described of processing of the image forming apparatus 1 according to the present embodiment.

FIG. 5 is a flowchart illustrating an example of a procedure of processing of the image forming apparatus. An algorithm illustrated in the flowchart of FIG. 5 is stored as a program in the storage 20, and is executed by the controller 10.

As illustrated in FIG. 5, first, the controller 10, as the PID controller 11, at the start of operation according to a new operation condition, refers to the table 21 stored in advance in the storage 20 to acquire a value of the constant term A corresponding to the operation condition (step S101). Note that, when the integral term is included in the expression (1), the controller 10 also resets a cumulative value of the deviation in the integral term at the time of step S101. Then, the controller 10 sets the value acquired in step S101 as the value of the constant term A included in the expression (1), and starts the operation according to the new operation condition that performs control according to the expression (1) (step S102).

Subsequently, the controller 10, as the confirmation unit 12, confirms an actual heater turn-on rate at every predetermined period while performing control according to the expression (1), and stores information regarding the confirmed heater turn-on rate in the storage 20 (step S103). Then, the controller 10 determines whether or not the operation according to the operation condition started in step S102 is ended (step S104). Note that, the “end of operation according to the operation condition” includes not only a case where operation according to the operation condition is ended and the state is returned to the standby state, but also a case where operation according to one operation condition is ended to start operation according to another operation condition (end of operation according to an operation condition before the change).

When determining that the operation started in step S102 is not ended (step S104: NO), the controller 10 repeatedly executes the processing of steps S103 and S104 until it is determined that the operation is ended. That is, the controller 10 repeats cumulatively storing the information regarding the heater turn-on rate confirmed at every predetermined period in the storage 20. Then, when determining that the operation is ended (step S104: YES), the controller 10 proceeds to the processing of step S105. Then, the controller 10, as the calculator 13, calculates the heater average turn-on rate during the execution of the operation on the basis of the information regarding the heater turn-on rate confirmed during the execution of the operation, which is stored in the storage 20 (step S105). That is, at the end of the operation according to the operation condition, the controller 10 calculates the heater average turn-on rate during the execution of the operation.

Subsequently, the controller 10, as the updater 14, updates the value of the constant term A acquired in step S101, which is included in the table 21, with the value of the heater average turn-on rate calculated in step S105 (step S106). Then, the controller 10 ends the processing. That is, at the end of the operation according to the operation condition, the controller 10 updates the value of the constant term A corresponding to the operation condition, which is included in the table 21, with the value of the heater average turn-on rate during the execution of the operation. Then, when starting the operation according to the same operation condition next time, the controller 10 sets the value updated this time as the value of the constant term A included in the expression (1). As a result, the controller 10 can perform control so that the heater turn-on rate immediately after the next start of the operation is equal to an actual heater average turn-on rate during the current execution of the operation. Thus, the controller 10 can control the heater turn-on rate so that the deviation between the detected temperature and the target temperature becomes smaller, from immediately after the next start of the operation, and can more effectively suppress the occurrence of the temperature ripple.

### Function and Effect

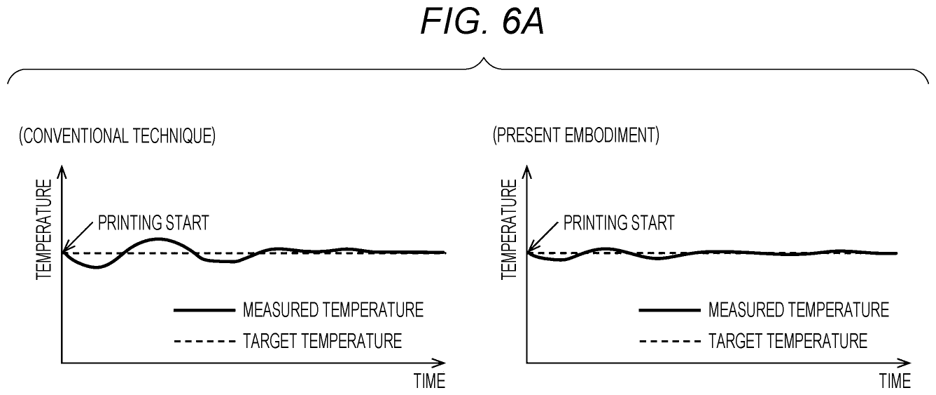

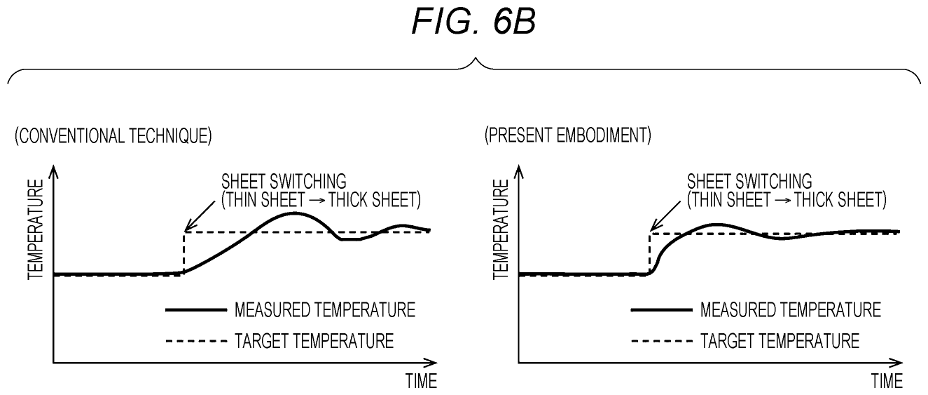

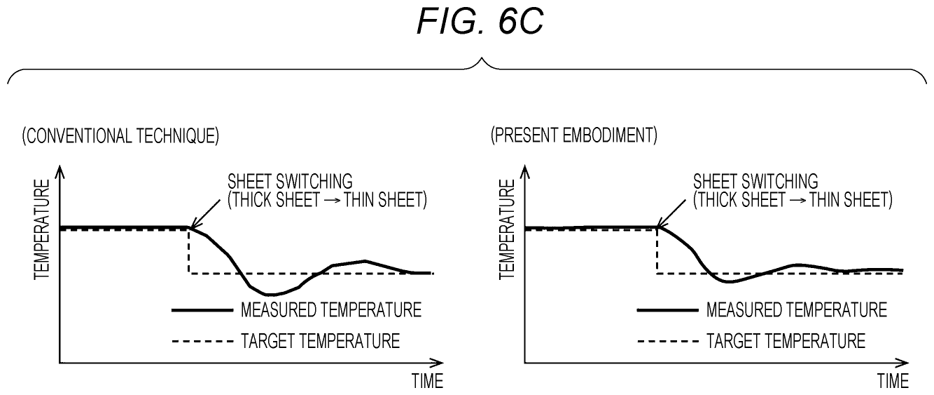

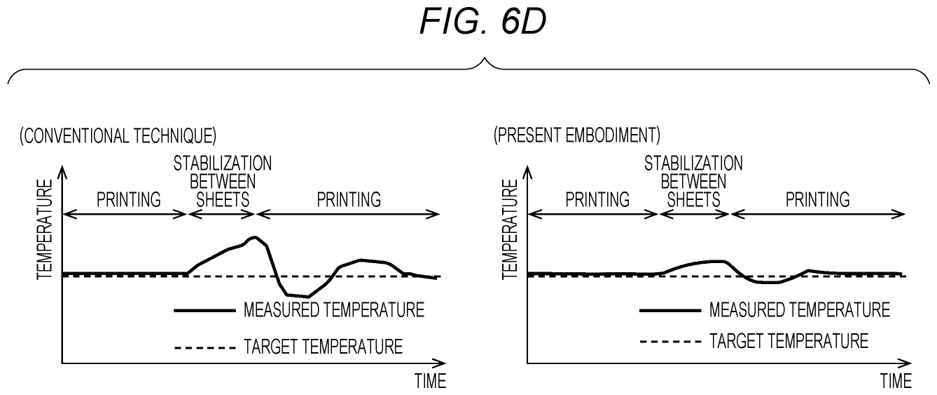

Subsequently, a function and effect will be described of the image forming apparatus 1 according to the present embodiment. FIGS. 6A to 6D are diagrams for explaining the function and effect of the image forming apparatus.

The image forming apparatus 1 executes control according to the expression (1) including the constant term A, whereby the magnitude of the temperature ripple that occurs at the start of printing on an arbitrary type of sheet can be reduced to about half or less compared to that in the conventional technology, as illustrated in FIG. 6A. Furthermore, the image forming apparatus 1 can reduce the magnitude of the temperature ripple that occurs due to change of the target temperature at the time of switching the type of the sheet from the thin sheet to the thick sheet, to about half or less compared to that in the conventional technology, as illustrated in FIG. 6B. Conversely, the image forming apparatus 1 can also reduce the magnitude of the temperature ripple that occurs at the time of switching the type of the sheet from the thick sheet to the thin sheet, to about half or less compared to that in the conventional technology, as illustrated in FIG. 6C. Moreover, the image forming apparatus 1 can reduce the magnitude of the temperature ripple that occurs at the time of executing the image stabilization processing between sheets, to about half or less compared to that in the conventional technology, as illustrated in FIG. 6D.

As described above, the image forming apparatus 1 performs PID control of the heater turn-on rate according to the deviation between the detected temperature and the target temperature, the PID control being in accordance with the expression (1) including at least the proportional term or the integral term and further including the constant term A of the value corresponding to the operation condition of the image forming apparatus. Then, the image forming apparatus 1 calculates the heater average turn-on rate during execution of the operation according to the operation condition, and updates the value of the constant term A corresponding to the operation condition with the value of the heater average turn-on rate. The image forming apparatus 1 can perform control so that the heater turn-on rate immediately after the start of the operation is equal to the heater average turn-on rate during the execution of the operation, by only updating the value of the constant term A with the value of the heater average turn-on rate. As a result, the image forming apparatus 1 can control the heater turn-on rate so that the deviation between the detected temperature and the target temperature becomes small from immediately after the start of the operation, and can easily suppress occurrence of the temperature ripple in the fixing device 80.

Furthermore, when the integral term is included in the expression (1), the image forming apparatus 1 resets the cumulative value of the deviation in the integral term at the start of the operation according to the operation condition. As a result, the image forming apparatus 1 can perform control so that the heater turn-on rate immediately after the start of the operation depends only on the value of the constant term A, and can more easily control the heater turn-on rate immediately after the start of the operation.

Furthermore, the operation condition includes the condition regarding the sheet type and basis weight of the sheet to be conveyed. As a result, the image forming apparatus 1 can perform control of the heater turn-on rate according to the expression (1) including the constant term A of a different value for each sheet type and basis weight of the sheet to be conveyed. Thus, the image forming apparatus 1 can set the optimal heater turn-on rate for each sheet type and basis weight of the sheet to be conveyed, from immediately after the start of the operation according to the operation condition.

Furthermore, the image forming apparatus 1 stores the table 21 that associates the operation condition and the value of the constant term A with each other, and refers to the table 21 at the start of the operation according to the operation condition, to acquire the value of the constant term A corresponding to the operation condition. As a result, the image forming apparatus 1 can easily manage values of a plurality of the constant terms A different for each operation condition in the table 21.

Furthermore, at the end of the operation according to the operation condition, the image forming apparatus 1 calculates the heater average turn-on rate during the execution of the operation, and updates the value of the constant term A included in the table 21 with the value of the heater average turn-on rate calculated. As a result, the image forming apparatus 1 can set the value updated this time as the value of the constant term A included in the expression (1) when the operation according to the same operation condition is started next time. Then, the image forming apparatus 1 can perform control so that the heater turn-on rate immediately after the next start of the operation is equal to the actual heater average turn-on rate during the current execution of the operation. Thus, the image forming apparatus 1 can control the heater turn-on rate so that the deviation between the detected temperature and the target temperature becomes smaller, from immediately after the next start of the operation, and can more effectively suppress the occurrence of the temperature ripple.

Note that, the present invention is not limited to the above-described embodiment, and various changes and improvements can be made within the scope of the claims

### Modification 1

In the above-described embodiment, a case has been described where the information regarding the heater turn-on rate confirmed at every predetermined period is stored in the storage 20, as an example; however, the information regarding the heater turn-on rate may be stored on the basis of a predetermined condition.

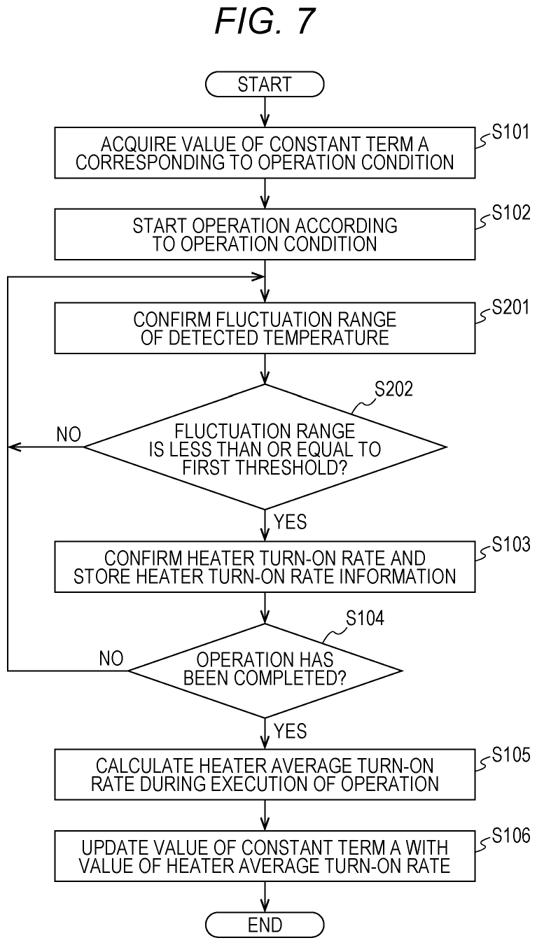

FIG. 7 is a flowchart illustrating another example of the procedure of the processing of the image forming apparatus.

Processing other than steps S201 and S202 illustrated in FIG. 7 is the same as the processing illustrated in FIG. 5, so that description thereof will be omitted. The controller 10 according to Modification 1 also functions as a determiner that performs a predetermined determination by reading a program and executing processing.

As illustrated in FIG. 7, the controller 10, as a determiner, confirms a current fluctuation range of the detected temperature by the temperature sensor 85 (step S201), and determines whether or not the fluctuation range of the detected temperature is less than or equal to a first threshold (step S202). The first threshold may be about several degrees Celsius (for example, 2° C.).

When determining that the fluctuation range of the detected temperature exceeds the first threshold (step S202: NO), the controller 10 repeatedly executes the processing of steps S201 and S202 until the fluctuation range of the detected temperature becomes less than or equal to the first threshold. Then, when determining that the fluctuation range of the detected temperature is less than or equal to the first threshold (step S202: YES), the controller 10 proceeds to the processing of step S103. As a result, the image forming apparatus 1 does not need to store, in the storage 20, the information regarding the heater turn-on rate during a period in which the fluctuation range of the detected temperature exceeds the first threshold. Thus, the image forming apparatus 1 can accurately calculate the heater average turn-on rate on the basis of only the heater turn-on rate during a period in which the fluctuation range of the detected temperature is less than or equal to the first threshold, that is, a period after the detected temperature has settled near the target temperature.

### Modification 2

In Modification 1, a case has been described where it is determined whether or not the fluctuation range of the detected temperature is less than or equal to the first threshold, as an example; however, a determination regarding a fluctuation range of the heater turn-on rate may be performed instead of the fluctuation range of the detected temperature.

More specifically, in step S201 illustrated in FIG. 7, the controller 10 according to Modification 2 may confirm the fluctuation range of the heater turn-on rate controlled by the PID controller 11 instead of confirming the fluctuation range of the detected temperature. Then, in step S202, the controller 10 may determine whether or not the fluctuation range of the heater turn-on rate is less than or equal to a second threshold instead of determining whether or not the fluctuation range of the detected temperature is less than or equal to the first threshold. The second threshold may be about several percent (for example, 7%). As a result, the image forming apparatus 1 can execute processing similar to the processing according to Modification 1 on the basis of the fluctuation range of the heater turn-on rate corresponding to the fluctuation range of the detected temperature. Thus, the image forming apparatus 1 can accurately calculate the heater average turn-on rate on the basis of only the heater turn-on rate during a period in which the fluctuation range of the heater turn-on rate is less than or equal to the second threshold, that is, during a period after the fluctuation has settled.

### Modification 3

In the above-described embodiment, a case has been described where the value of the constant term A included in the table 21 is updated with the value of the heater average turn-on rate every time the heater average turn-on rate is calculated, as an example; however, the value of the constant term A may be updated only when a predetermined condition is satisfied.

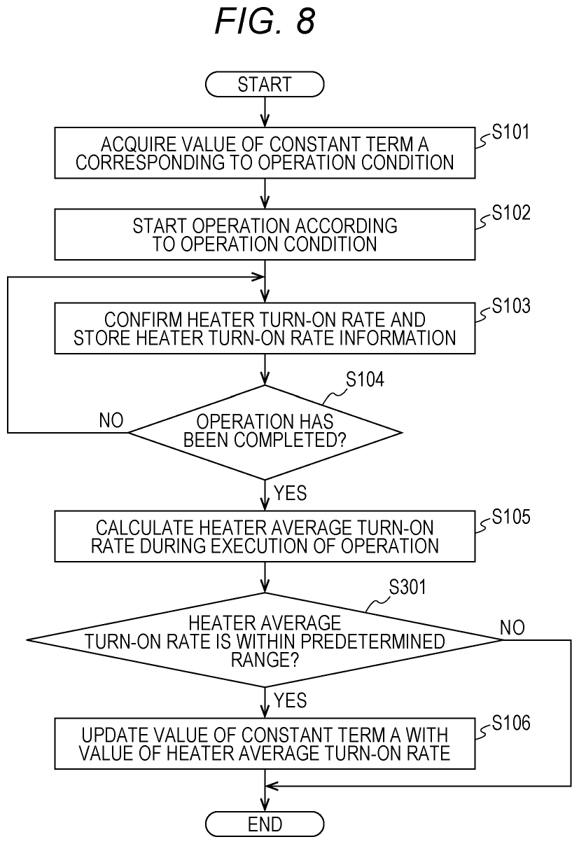

FIG. 8 is a flowchart illustrating yet another example of the procedure of the processing of the image forming apparatus.

Processing other than step S301 illustrated in FIG. 8 is the same as the processing illustrated in FIG. 5, so that description thereof will be omitted. Similarly to the controller 10 according to Modification 1, the controller 10 according to Modification 3 also functions as a determiner that performs a predetermined determination by reading a program and executing processing.

As illustrated in FIG. 8, the controller 10, as a determiner, determines whether or not the heater average turn-on rate calculated in step S105 is included in a predetermined range (step S301). The predetermined range may be, for example, a range of about ±15% with the value of the constant term A corresponding to the operation condition determined to be ended in step S104, which is included in the table 21, as a median value. Then, when determining that the heater average turn-on rate is included in the predetermined range (step S301: YES), the controller 10 proceeds to the processing of step S106. On the other hand, when determining that the heater average turn-on rate is not included in the predetermined range (step S301: NO), the controller 10 ends the processing as it is. As a result, the image forming apparatus 1 can avoid erroneously updating the value of the constant term A included in the table 21 due to an abnormal value of the heater average turn-on rate not included in the predetermined range, or the like. More specifically, for example, the image forming apparatus 1 can avoid erroneously associating the type of the sheet erroneously stored in the sheet feeding tray with the value of the constant term A included in the table 21, and erroneously updating the value of the constant term A included in the table 21. Alternatively, the image forming apparatus 1 can also avoid erroneously updating the value of the constant term A included in the table 21 on the basis of an abnormal value of the heater average turn-on rate caused by an abnormal state of the image forming apparatus 1 that has suddenly occurred or the like. Note that, Modification 3 may be used in combination with Modification 1 or Modification 2.

### Modification 4

In the above-described embodiment, a case has been described where the control according to the expression (1) is performed, as an example; however, control according to another expression may be performed.

The controller 10 according to Modification 4 performs control according to the following expression (2) in step S102 instead of the expression (1) according to the above-described embodiment.

$$\begin{matrix} [ Expression 2 ] & \\ HEATER TURN \text{-} ON RATE = {K}_{p} e ( t ) + {K}_{i} {\int }_{0}^{t} e ( τ ) d τ + {K}_{d} \frac{de ( t )}{dt} + A & ( 2 )\end{matrix}$$

The expression (2) according to Modification 4 is characterized in that the expression (2) includes a constant term (constant term kA) of a value corrected by a coefficient k, as compared with the expression (1) according to the above-described embodiment. The coefficient k is calculated on the basis of, for example, a coefficient k1 based on an environmental condition of the image forming apparatus 1, a coefficient k2 based on a warm-up condition of the fixing device 80, and the following expression (3). However, the method of calculating the coefficient k is not limited to the example illustrated in the expression (3).

[Expression 3]

k=k1×k2 (3)

Here, the coefficient kl may be, for example, a coefficient regarding the temperature (the internal temperature or the external temperature) of an environment in which the image forming apparatus 1 is installed. In this case, when the temperature is less than 15° C., the coefficient k1 may be set to 1.1, and when the temperature is higher than or equal to 15° C. and less than 25° C., the coefficient k1 may be set to 1.0, and when the temperature is higher than or equal to 25° C., the coefficient k1 may be set to 0.9. Furthermore, the coefficient k2 may be, for example, a coefficient regarding an elapsed time from the start of warm-up of the fixing device 80. In this case, when the elapsed time is within 5 minutes, the coefficient k2 may be set to 1.2, and when the elapsed time exceeds 5 minutes and is within 10 minutes, the coefficient k2 may be set to 1.1, and when the elapsed time exceeds 10 minutes, the coefficient k2 may be set to 1.0. Then, for example, when the temperature of the environment is less than 15° C., and the elapsed time from the start of the warm-up is within 5 minutes, the coefficient k may be set to 1.32 on the basis of the expression (3). As described above, the image forming apparatus 1 can set the value of the constant term kA larger and set the heater turn-on rate higher, as the temperature of the installation environment is lower and, moreover, as the elapsed time from the start of the warm-up of the fixing device 80 is shorter. As a result, the image forming apparatus 1 can control the heater turn-on rate in consideration of the environmental condition of the image forming apparatus 1 and the warm-up condition of the fixing device 80, and can more effectively suppress the occurrence of temperature ripple.

Furthermore, when updating the value of the constant term A included in the table 21 in step S106, the controller 10 according to Modification 4 may update the value of the constant term A with a value obtained by dividing the value of the heater average turn-on rate by the value of the set coefficient k. As a result, the image forming apparatus 1 can update the value of the constant term A with a value of a normalized heater average turn-on rate that is not affected by the environmental condition of the image forming apparatus 1 or the warm-up condition of the fixing device 80. Note that, Modification 4 may be used in combination with Modification 1 or Modification 2, and Modification 3.

In addition, in the above-described embodiment, a case has been described where the heating roller 83 including the heater 831, and the fixing belt 84 are provided on the fixing roller 81 side in the fixing device 80, as an example; however, the configuration of the fixing device 80 is not limited to the above-described example. For example, a heater may be provided inside the fixing roller 81, and the heating roller 83 and the fixing belt 84 may be omitted. Alternatively, the fixing device 80 may have a configuration that implements a lower belt fixing system in which a fixing belt is provided on the pressure roller 82 side, or an upper and lower belt fixing system in which fixing belts are respectively provided on both of the fixing roller 81 side and the pressure roller 82 side, instead of the upper belt fixing system in which the fixing belt 84 is provided on the fixing roller 81 side.

Furthermore, in the above-described embodiment, a case has been described where the value of the constant term A corresponding to the operation condition during printing is set, as an example; however, a value of the constant term A corresponding to another operation condition may be further set. For example, a value of the constant term A corresponding to during warm-up of the fixing device 80, or a value of the constant term A corresponding to during standby of the image forming apparatus 1, or the like may be further set.

Furthermore, in the above-described embodiment, the image forming apparatus 1 has been described as one apparatus; however, for the image forming apparatus 1, for example, an information processing apparatus that performs various types of determination processing and an apparatus that executes image forming processing may be separately configured and connected to each other via a bus.

Furthermore, the processing according to the above-described embodiment may include a step other than the above-described steps, or does not have to include some of the above-described steps. Furthermore, the order of the steps is not limited to that in the above-described embodiment. Moreover, each step may be combined with another step to be executed as one step, may be included in another step to be executed, may be divided into a plurality of steps to be executed, or may be simultaneously executed with another step.

Furthermore, the unit and method for performing various types of processing in the image forming apparatus 1 according to the above-described embodiment can be implemented by any of a dedicated hardware circuit and a programmed computer. The above-described program may be provided by a computer-readable recording medium, for example, a compact disc read only memory (CD-ROM), or the like, or may be provided online via a network such as the Internet. In this case, the program recorded in the computer-readable recording medium is usually transferred to and stored in a storage such as a hard disk. Furthermore, the above-described program may be provided as standalone application software or may be incorporated as one function of the image forming apparatus 1 into its software.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising:
an image forming device that forms an image on a sheet;
a fixing device that includes a heating member and heats the sheet on which the image is formed by the image forming device, to fix the image on the sheet;
a detector that detects a temperature in the fixing device; and
a hardware processor that performs PID control of a turn-on rate of the heating member according to a deviation between a detected temperature by the detector and a target temperature, the PID control being in accordance with an expression including at least a proportional term or an integral term and further including a constant term of a value corresponding to an operation condition of the image forming apparatus, wherein
the hardware processor calculates, at an end of operation according to the operation condition, an average turn-on rate of the heating member during execution of the operation, and
the hardware processor updates the value of the constant term corresponding to the operation condition with a value of the average turn-on rate calculated by the hardware processor.

2. The image forming apparatus according to claim 1, wherein the hardware processor resets a cumulative value of the deviation in the integral term at a start of the operation according to the operation condition when the expression includes the integral term.

3. The image forming apparatus according to claim 1, wherein the operation condition includes a condition regarding a sheet type and a basis weight of the sheet.

4. The image forming apparatus according to claim 1, further comprising
a storage that stores a table that associates the operation condition and the value of the constant term with each other, wherein
the hardware processor, at a start of the operation according to the operation condition, refers to the table to acquire the value of the constant term corresponding to the operation condition, and performs control according to the expression including the constant term of the value acquired, and
the hardware processor, at the end of the operation according to the operation condition, updates the value of the constant term included in the table with the value of the average turn-on rate calculated by the hardware processor.

5. The image forming apparatus according to claim 1, wherein the hardware processor calculates the average turn-on rate on the basis of the turn-on rate during a period in which a fluctuation range of the detected temperature is less than or equal to a first threshold.

6. The image forming apparatus according to claim 1, wherein the hardware processor calculates the average turn-on rate on the basis of the turn-on rate during a period in which a fluctuation range of the turn-on rate is less than or equal to a second threshold.

7. The image forming apparatus according to claim 1, wherein
the hardware processor determines whether or not the average turn-on rate is included in a predetermined range, and
the hardware processor
updates the value of the constant term when it is determined that the average turn-on rate is included in the predetermined range, by the hardware processor, and
does not update the value of the constant term when it is determined that the average turn-on rate is not included in the predetermined range, by the hardware processor.

8. The image forming apparatus according to claim 1, wherein the hardware processor performs control according to the expression including the constant term of a value corrected on the basis of an environmental condition of the image forming apparatus and a warm-up condition of the fixing device.

9. A non-transitory recording medium storing a computer readable control program for an image forming apparatus including: an image forming device that forms an image on a sheet; a fixing device that includes a heating member and heats the sheet on which the image is formed by the image forming device, to fix the image on the sheet; and a detector that detects a temperature in the fixing device,
the control program causing a computer to execute processing including:
performing PID control of a turn-on rate of the heating member according to a deviation between a detected temperature by the detector and a target temperature, the PID control being in accordance with an expression including at least a proportional term or an integral term and further including a constant term of a value corresponding to an operation condition of the image forming apparatus;
calculating, at an end of operation according to the operation condition, an average turn-on rate of the heating member during execution of the operation; and
updating the value of the constant term corresponding to the operation condition with a value of the average turn-on rate calculated in the calculating.
